(19) United States
(12) Patent Application Publication
(10) Pub. No.: US 2010/0175096 A1
(43) Pub. Date: Jul. 8, 2010

(54) TRANSMISSION METHOD, TRANSMISSION APPARATUS, RECEPTION METHOD, RECEPTION APPARATUS OF DIGITAL BROADCASTING SIGNAL AND TRANSMISSION FRAME-FORM THEREOF

(75) Inventors: Jae Hyun Seo, Daejeon (KR); Hyoung Soo Lim, Daejeon (KR); Yong Tae Lee, Daejeon (KR); Heung Mook Kim, Daejeon (KR); Sung Ik Park, Daejeon (KR); Jong Soo Lim, Daejeon (KR); Soo In Lee, Daejeon (KR)

Correspondence Address: LADAS & PARRY LLP, 224 SOUTH MICHIGAN AVENUE, SUITE 1600, CHICAGO, IL, 60604, US

(73) Assignee: Electronics & Telecommunications Research Institute, Daejeon (KR)

(21) Appl. No.: 12/602,122

(22) PCT Filed: May 30, 2008
(86) PCT No.: PCT/KR2008/003072

§ 371 Date: Nov. 27, 2009

(30) Foreign Application Priority Data
May 31, 2007 (KR) 10-2007-0053246
May 29, 2008 (KR) 10-2008-0050263

(51) Int. Cl. H04N 7/173

(52) U.S. Cl. 725/109

(57) ABSTRACT

The present invention relates to a transmission method, a transmission apparatus, a reception method, and a reception apparatus of a digital broadcasting signal that can add frame header information to a front portion of a transmission frame in a transmission system for digital broadcasting to thereby determine a different transmission mode, modulation level, hierarchical modulation, error correction code, and the like for each temporally different transmission frame, and a transmission frame structure thereof. The transmission frame structure includes a frame header containing multiplexing information of the transmission frame, and a frame body containing data information associated with a service provided by the transmission frame. Also, the frame header may include a frame synchronization signal unit including synchronization signal information for extracting a start position of the transmission frame and a frame information unit including multiplexing information of data contained in the transmission frame. The multiplexing information denotes information associated with a transmission mode, a modulation level, a hierarchical modulation, and an error correction code of the data contained in the transmission frame.

### TECHNICAL FIELD

The present invention relates to a transmission method, a transmission apparatus, a reception method, and a reception apparatus of a digital broadcasting signal, and a transmission frame structure thereof. Particularly, the present invention relates to a transmission method, a transmission apparatus, a reception method, and a reception apparatus of a digital broadcasting signal that can support various types of transmission modes in terrestrial digital broadcasting, such as a digital television (DTV) and digital multimedia broadcasting (DMB), and a transmission frame structure thereof.

The present invention was supported by the IT R&D program of MIC/IITA [2006-S-016-02, Development of Distributed Repeating Technology for Terrestrial DTV].

### BACKGROUND ART

Representative examples of terrestrial digital broadcasting include a digital television (DTV) and digital multimedia broadcasting (DMB). In particular, the DMB provides various types of multimedia broadcasting services by adding a video service standard to the Eureka-147 digital audio broadcasting (DAB) system of Europe.

In the terrestrial digital broadcasting, the configuration or length of a transmission frame is different according to a transmission mode. Eureka-147 DAB defines (I) a transmission mode for terrestrial broadcasting of a single frequency network, (II) a transmission mode for terrestrial broadcasting of a multiplex frequency network, (III) a transmission mode for cable broadcasting, and (IV) a transmission mode for terrestrial-and-satellite mixed broadcasting.

The existing terrestrial digital broadcasting constitutes a transmission frame for each transmission mode in order to support various types of transmission modes. Specifically, the terrestrial digital broadcasting generates a transmission frame supporting a modulation level supporting a corresponding transmission mode, a hierarchical modulation, and an error correction code, for each transmission mode, and provides the generated transmission frame of the corresponding transmission mode according to a user's desired service.

Accordingly, there is an increasing need for a single consistent transmission frame structure that can support various types of transmission modes in order to provide a user with diversified services.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Problem

The present invention has been made in an effort to provide a transmission method, a transmission apparatus, a reception method, and a reception apparatus of a digital broadcasting signal, having advantages of supporting various types of transmission modes in terrestrial digital broadcasting such as a digital television (DTV) and digital multimedia broadcasting (DMB), and the transmission frame structure thereof.

### Technical Solution

An exemplary embodiment of the present invention provides a transmission apparatus of a digital broadcasting signal.

The transmission apparatus includes a stream provider that converts each of a plurality of program service components into a stream, a multiplexer that modulates the stream using a predetermined scheme according to a transmission mode, and a transmission frame generator that generates a transmission frame on the basis of multiplexing information according to the transmission mode and stream information allocated to each subchannel. Herein, the transmission frame includes a frame header containing multiplexing information of the transmission frame and a frame body containing data information associated with a service provided by the transmission frame.

The multiplexer may include a plurality of mode modulation units according to the transmission mode. Each mode modulation unit may include an encoder that encodes the stream according to a predetermined bit rate, a media multiplexer that packetizes the encoded stream with respect to each of a plurality of components included in a multiplexing service, an external encoder that performs error correction-oriented external encoding on the multiplexed stream, and a channel distributor that allocates the external-encoded stream to each subchannel using the predetermined scheme.

Another exemplary embodiment of the present invention provides a transmission method of a digital broadcasting signal.

The transmission method includes converting each of a plurality of program service components into a stream; modulating the stream using a plurality of schemes according to a transmission mode; generating a transmission frame on the basis of multiplexing information according to the transmission mode and stream information allocated to each subchannel, the transmission frame including the multiplexing information in a frame header; and transmitting the transmission frame to a user terminal.

Still another exemplary embodiment of the present invention provides a structure of a transmission frame.

The structure of the transmission frame includes a frame header that includes multiplexing information of the transmission frame, and a frame body that includes data information associated with a service provided by the transmission frame.

The frame header may include a frame synchronization signal unit that includes synchronization signal information for extracting a start position of the transmission frame; and a frame information unit that includes multiplexing information of data contained in the transmission frame, the multiplexing information including information associated with a transmission mode, a modulation level, a hierarchical modulation, and an error correction code of the data contained in the transmission frame.

Yet another exemplary embodiment of the present invention provides a reception apparatus of a digital broadcasting signal.

The reception apparatus includes a frame header analysis unit that determines whether multiplexing information of a received transmission frame is appropriate for a transmission mode of a corresponding digital broadcasting signal receiving apparatus, and a demultiplexer that demodulates only a transmission frame determined to be appropriate for the transmission mode by the frame header analysis unit using a predetermined scheme associated with the transmission mode.

The frame header analysis unit may include: an extractor that extracts a frame header of the received transmission frame; a multiplexing information analysis unit that analyzes multiplexing information of the transmission frame using the frame header, the multiplexing information including information associated with a transmission mode, a modulation level, a hierarchical modulation, and an error correction code of data contained in the transmission frame; and a determination unit that determines whether the analyzed multiplexing information is appropriate for the corresponding digital broadcasting signal receiving apparatus.

A further exemplary embodiment of the present invention provides a reception method of a digital broadcasting signal.

The reception method includes extracting a frame header of a received transmission frame, analyzing multiplexing information of data included in the transmission frame using the frame header, determining whether the analyzed data multiplexing information is appropriate for a transmission mode of a corresponding digital broadcasting signal receiving apparatus, and demodulating the transmission frame using a predetermined scheme associated with the transmission mode when it is determined that the analyzed data multiplexing information is appropriate for the corresponding digital broadcasting signal receiving apparatus.

### Advantageous Effects

According to exemplary embodiments of the present invention, there may be provided a transmission method, a transmission apparatus, a reception method, and a reception apparatus of a digital broadcasting signal that can support various types of transmission modes in terrestrial digital broadcasting such as a digital television (DTV), digital multimedia broadcasting (DMB), and the like.

### BRIEF DESCRIPTION OF THE DRAWINGS

FIG. 1 is a block diagram illustrating the configuration of a digital broadcasting signal transmitting apparatus according to an exemplary embodiment of the present invention.

FIG. 2 is a block diagram illustrating the configuration of a first mode modulation unit 200_(1) according to an exemplary embodiment of the present invention.

FIG. 3 is a diagram illustrating a structure of a transmission frame according to an exemplary embodiment of the present invention.

FIG. 4 is a flowchart illustrating a transmission method of a digital broadcasting signal according to an exemplary embodiment of the present invention.

FIG. 5 is a diagram illustrating an example of using a transmission frame according to an exemplary embodiment of the present invention.

FIG. 6 is a diagram illustrating a specific structure of a transmission frame according to an exemplary embodiment of the present invention.

FIG. 7 is a block diagram illustrating the configuration of a digital broadcasting signal receiving apparatus according to an exemplary embodiment of the present invention.

FIG. 8 is a flowchart illustrating a reception method of a digital broadcasting signal according to an exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise”, and variations such as “comprises” and “comprising”, will be understood to imply the inclusion of stated elements but not the exclusion of any other elements. In addition, the terms “-er”, “-or”, and “module” described in the specification mean units for processing at least one function and operation and can be implemented by hardware components, software components, and combinations thereof.

Hereinafter, a transmission method, a transmission apparatus, a reception method, and a reception apparatus of a digital broadcasting signal, and a transmission frame structure thereof according to an exemplary embodiment of the present invention will be described in detail with reference to the accompanying drawings.

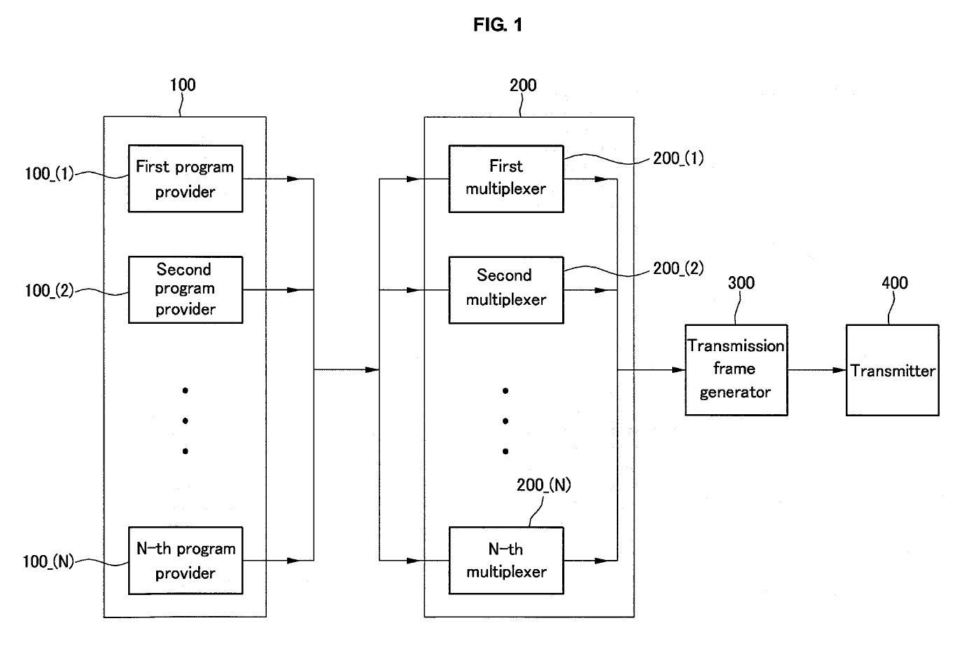

FIG. 1 is a block diagram illustrating the configuration of a digital broadcasting signal transmitting apparatus according to an exemplary embodiment of the present invention.

Referring to FIG. 1, the digital broadcasting signal transmitting apparatus according to the exemplary embodiment of the present invention includes a stream provider 100, a multiplexer 200, a transmission frame generator 300, and a transmitter 400. Hereinafter, the configuration of each component shown in FIG. 1 will be described.

The stream provider 100 includes first to N-th program providers 100_(1), 100_(2,) . . . , and 100_(N). Each of the first to N-th program providers 100_(1), 100_(2,) . . . , and 100_(N) converts a program service component into a stream and transmits the converted stream to the multiplexer 200. In this case, each of a plurality of programs includes at least one service component (hereinafter, referred to as “service”). Also, the at least one service includes a video service, an audio service, and a data service.

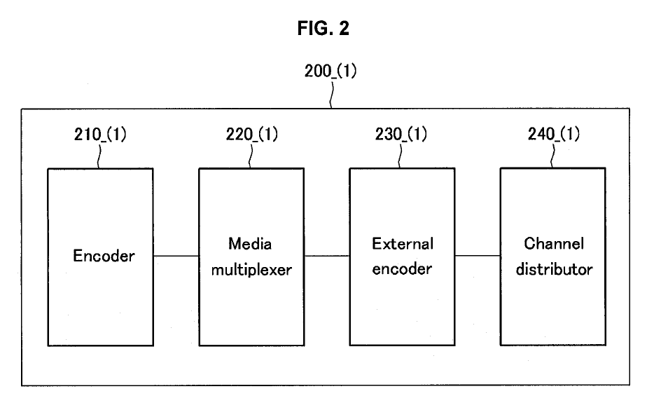

The multiplexer 200 includes first to N-th mode modulation units 200_(1), 200_(2), . . . , and 200_(N), and modulates a plurality of streams, received from the stream provider 100, using a predetermined scheme determined by each of the mode modulation units 200_(1), 200_(2), . . . , and 200_(N). A specific configuration of the multiplexer 200 will be described later with reference to FIG. 2.

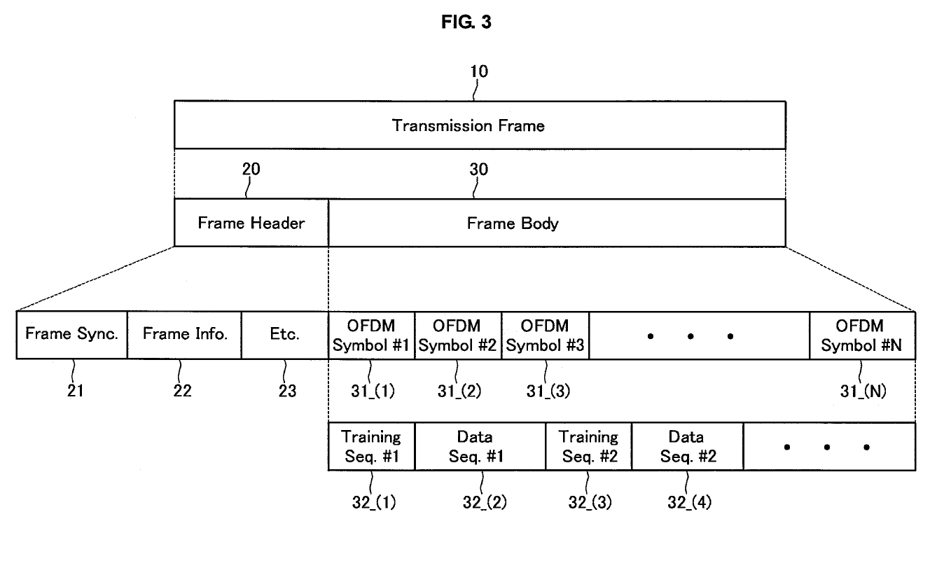

The transmission frame generator 300 generates a transmission frame on the basis of each multiplexing information and stream allocated to each subchannel by each of the first to N-th mode modulation units 200_(1), 200_(2), . . . , and 200_(N). A specific configuration of the transmission frame will be described later with reference to FIG. 3.

The transmitter 400 transmits, to a user terminal, the transmission frame generated by the transmission frame generator 300.

FIG. 2 is a block diagram illustrating the configuration of the first mode modulation unit 200_(1) according to an exemplary embodiment of the present invention.

For convenience of description, only the configuration of the first mode modulation unit 200_(1) of the multiplexer 200 will be herein described. The other mode modulation units 200_(2), . . . , and 200_(N) have the same configuration as the configuration of the first mode modulation unit 200_(1), except for predetermined modulation schemes.

Referring to FIG.2, the first mode modulation unit 200_(1) according to the exemplary embodiment of the present invention includes an encoder 210_(1), a media multiplexer 220_(1), an external encoder 230_(1), and a channel distributor 240_(1).

The encoder 210-(1) encodes a plurality of streams received from the stream provider 100, on the basis of a predetermined bit rate. Specifically, the encoder 210_(1) of the first mode modulation unit 200_(1) encodes the plurality of streams received from the stream provider 100 on the basis of a predetermined bit rate of the first mode modulation unit 200_(1) to generate a first stream.

The media multiplexer 220_(1) multiplexes the encoded stream generated by the encoder 210_(1). Here, “multiplexing” means performing packetized elementary stream (PES) for each of a plurality of constituent elements included in the service, for example, in the case of a video service, for each of audio, video, control data, subtitles, etc. Also, the media multiplexer 220_(1) may multiplex the stream using an MPEG-2 transport stream (TS) scheme that is applied in a general digital television (DTV), or an MPEG-4 TS scheme that is applied in general digital multimedia broadcasting (DMB).

The external encoder 230_(1) performs error correction-oriented external encoding for the multiplexed stream received from the media multiplexer 220_(1). In this case, when the external encoder 230_(1) performs external encoding on a stream corresponding to a video service, the external encoder 230_(1) may be a Reed-Solomon (RS) encoder.

The channel distributor 240_(1) allocates to the subchannel the stream received from the external encoder 230_(1) using a predetermined scheme of the first mode modulation unit 200_(1).

FIG. 3 is a diagram illustrating a structure of a transmission frame according to an exemplary embodiment of the present invention.

Referring to FIG. 3, the transmission frame 10 according to the exemplary embodiment of the present invention includes a frame header 20 and a frame body 30.

The frame header 20 includes multiplexing information of data contained in the frame body 30. The frame header 20 includes a frame synchronization signal unit (Frame Sync. in FIG. 3) 21, a frame information unit (Frame Info. in FIG. 3) 22, and others (Etc. in FIG. 3) 23.

The frame synchronization signal unit 21 includes synchronization signal information for extracting a start position of the transmission frame. The frame information unit 22 includes multiplexing information of data contained in the frame body 30. Specifically, the frame information unit 22 includes information associated with a transmission mode, a modulation level, a hierarchical modulation, an error correction code, and the like of the data contained in the frame body 30. Also, the others 23 include further information that needs to be included in the transmission frame.

The frame body 30 includes data information associated with a service provided by the transmission frame. Specifically, the frame body 30 corresponds to a data section that includes contents information in the transmission frame. Also, the frame body 30 may include orthogonal frequency domain division multiplexing (OFDM) symbols of a multi-carrier scheme, or a training sequence and data sequence of a single-carrier scheme.

In the case of the multi-carrier scheme, the frame body 30 includes N OFDM symbols, for example, OFDM symbol #1 (31_(1)) to OFDM symbol #N (31_(N)).

On the other hand, in the case of the single-carrier scheme, the frame body 30 consists of training seq.#1 (32_(1)), data seg.#1 (32_(2)), training seq.#2 (32_(3)), data seg.#2 (32_(4)), and the like.

Specifically, a transmission frame according to an exemplary embodiment of the present invention may include, in its front portion, a frame header containing multiplexing information of data provided by the transmission frame. Temporally different transmission frames in a single band may support different transmission modes using a frame header. Specifically, the temporally different transmission frames in the single band may include information such as different modulation levels, hierarchical levels, error correction codes, and the like.

Also, since the temporally different transmission frames support the different transmission modes, it is possible to selectively receive only a desired transmission frame and receive a service using a frame header.

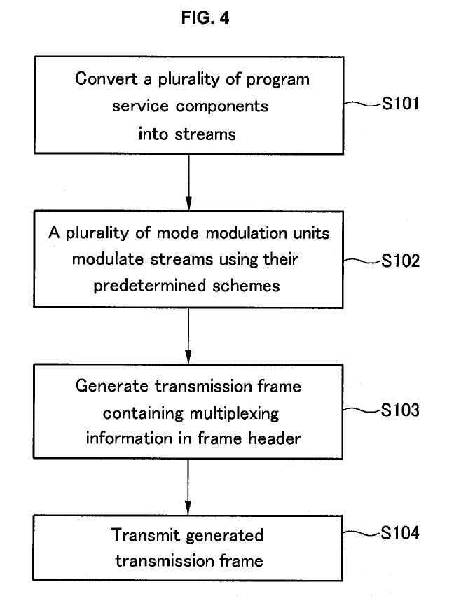

FIG. 4 is a flowchart illustrating a transmission method of a digital broadcasting signal according to an exemplary embodiment of the present invention.

Referring to FIG. 4, a digital broadcasting signal transmitting apparatus converts a plurality of program service components into streams (S101). Next, the digital broadcasting signal transmitting apparatus may modulate the converted streams using a plurality of schemes according to each corresponding transmission mode. The first to N-th mode modulation units 200_(1), 200_(2), . . . , and 200_(N) modulate the streams using a scheme set in each mode modulation unit (S102).

Then, the digital broadcasting signal transmitting apparatus generates a transmission frame on the basis of multiplexing information of each of the first to N-th mode modulation units 200_(1), 200_(2), . . . , and 200_(N) and stream information allocated to each subchannel (S103). Specifically, the digital broadcasting signal transmitting apparatus may generate a transmission frame containing multiplexing information in a frame header.

Then, the digital broadcasting signal transmitting apparatus transmits the generated transmission frame to a user terminal (S104).

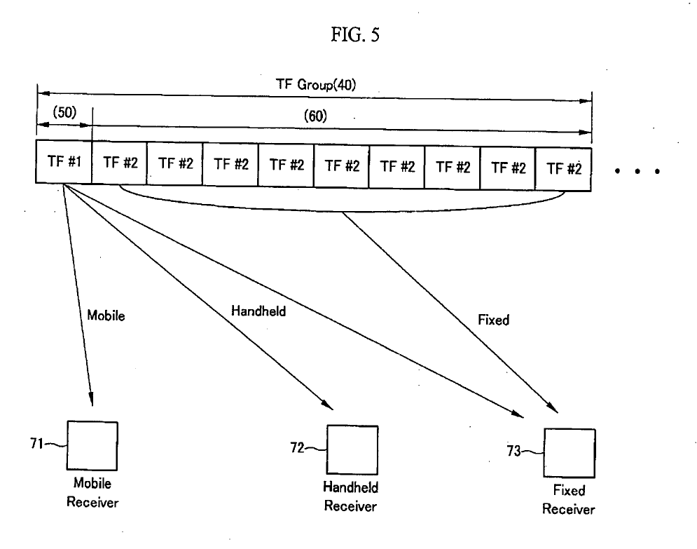

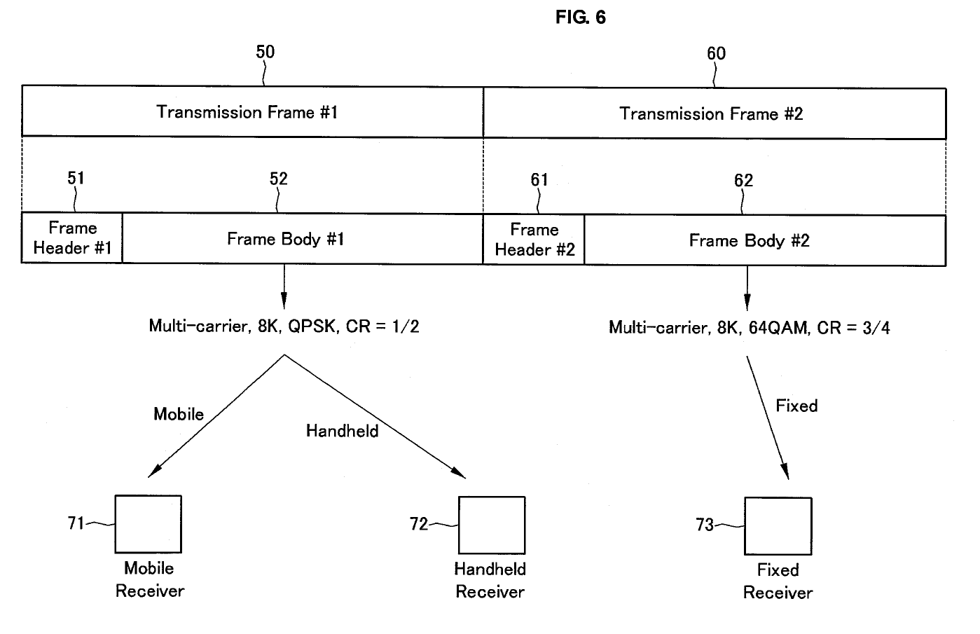

FIG. 5 is a diagram illustrating an example of using a transmission frame according to an exemplary embodiment of the present invention, and FIG. 6 is a diagram illustrating a specific structure of a transmission frame according to an exemplary embodiment of the present invention.

Referring to FIG. 5, the entire transmission frame includes a plurality of transmission frame groups (TF groups) 40. Each TF group 40 includes a first mode transmission frame (TF #1) 50 and a plurality of second mode transmission frames (TF #2) 60.

Referring to FIG. 6, the first mode transmission frame (TF #1) 50 is an OFDM transmission frame and relates to data symbols in the case of a multi-carrier mode, an 8K transmission mode, a quadrature phase shift keying (QPSK) modulation, and a code rate (CR) of ½. Also, the second mode transmission frame (TF #2) 60 is an OFDM transmission frame and relates to data symbols in the case of a multi-carrier mode, an 8K transmission mode, a 64-quadrature amplitude modulation (QAM), and a CR of ¾.

The first mode transmission frame 50 includes a first mode frame header (frame header #1) 51 and a first mode frame body (frame body #1) 52.

The first mode frame header (frame header #1) 51 includes multiplexing information indicating that data provided by the transmission frame is modulated in “multi-carrier mode, 8K transmission mode, QPSK modulation, and CR of ½”. Also, the first mode frame body (frame body #1) 52 includes data information in the case of “multi-carrier mode, 8K transmission mode, QPSK modulation, and CR of ½”.

The second mode transmission frame 60 includes a second mode frame header (frame header #2) 61 and a second mode frame body (frame body #2) 62.

The second mode frame header (frame header #2) 61 includes multiplexing information indicating that data provided by the transmission frame is modulated in “multi-carrier mode, 8K transmission mode, 64 QAM, and CR of ¾”. The second mode frame body (frame body #2) 62 includes data information in the case of “multi-carrier mode, 8K transmission mode, 64 QAM, and CR of ¾”.

A digital broadcasting signal receiving apparatus may extract the frame header 51 or 61 of each transmission frame to thereby analyze information associated with data constituting the frame body 51 or 62 of each transmission frame.

For example, it is assumed that the TF #1 50 is in a transmission form appropriate for a mobile receiver 71 in a mobile reception environment and a handheld receiver 72 in a handheld reception environment, and that the TF #2 60 is in a transmission form appropriate for a fixed receiver 74 in a fixed reception environment.

In this case, each of the digital broadcasting signal receiving apparatuses 71, 72, and 73 analyzes corresponding transmission frame information using the frame header 51 or 61 of the transmission frame to determine whether or not to process the data. Each digital broadcasting signal receiving apparatus selectively receives only data multiplexed to be appropriate for each apparatus, using a frame header of a transmission frame. Through this, since a digital broadcasting signal receiving apparatus selectively receives and processes only necessary data of the transmission frame, it is possible to reduce the power consumption.

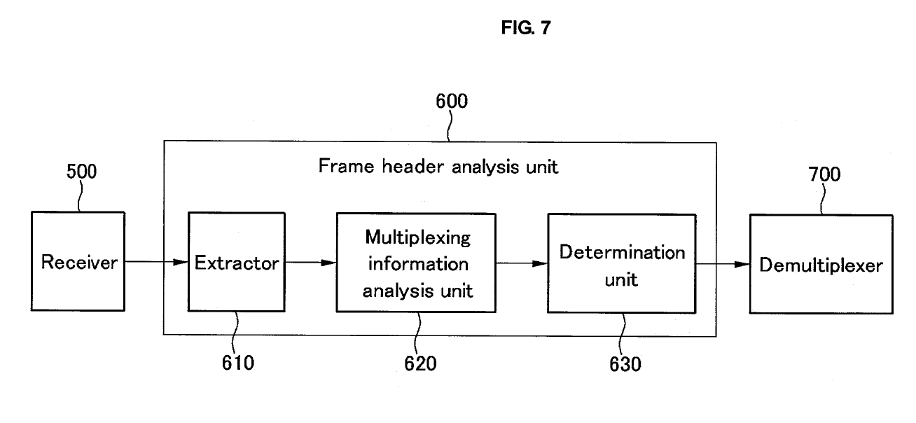

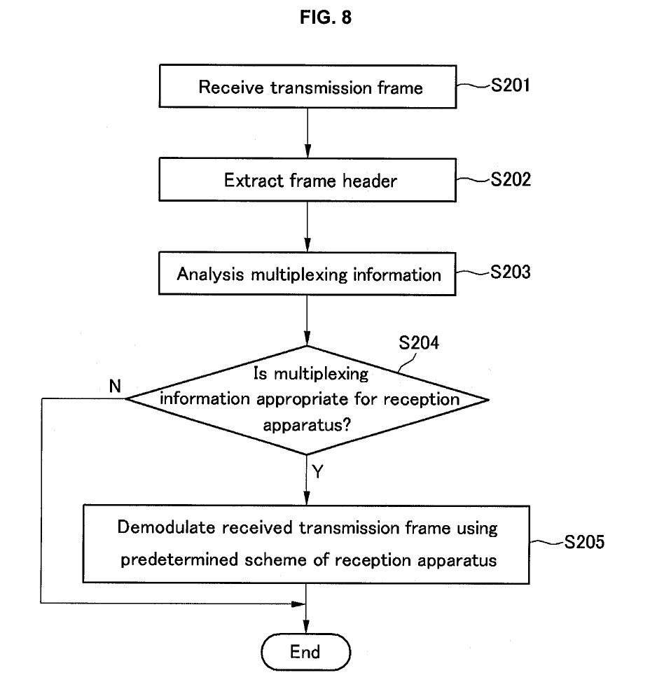

Hereinafter, a reception apparatus and a reception method of a digital broadcasting signal according to an exemplary embodiment of the present invention will be described in detail with reference to FIGS. 7 and 8.

FIG. 7 is a block diagram illustrating the configuration of a digital broadcasting signal receiving apparatus according to an exemplary embodiment of the present invention.

Referring to FIG. 7, the digital broadcasting signal receiving apparatus according to an exemplary embodiment of the present invention includes a receiver 500, a frame header analysis unit 600, and a demultiplexer 700. Hereinafter, the configuration of each component of FIG. 7 will be described.

The receiver 500 receives the transmission frame 10 from a digital broadcasting signal transmitting apparatus.

The frame header analysis unit 600 includes an extractor 610, a multiplexing information analysis unit 620, and a determination unit 630. When it is determined that multiplexing information of the received transmission frame 10 is appropriate for the corresponding digital broadcasting signal receiving apparatus, the frame header analysis unit 600 transmits the received transmission frame 10 to the demultiplexer 700.

The extractor 610 extracts a frame header 20 of the transmission frame 10 received from the receiver 500.

The multiplexing information analysis unit 620 analyzes multiplexing information of data contained in a frame body 30 using a frame information unit 22 of the frame header. Specifically, the multiplexing information denotes information such as a transmission mode, a modulation level, a hierarchical modulation, an error correction code, and the like with respect to data included in the frame body 30.

The determination unit 630 determines whether the data multiplexing information analyzed by the multiplexing information analysis unit 620 is appropriate for the corresponding digital broadcasting signal receiving apparatus. Also, when it is determined that the analyzed data multiplexing information is appropriate for the corresponding digital broadcasting signal receiving apparatus, the determination unit 630 transmits, to the demultiplexer 700, the transmission frame received by the receiver 500.

The demultiplexer 700 demodulates the transmission frame 10 received from the digital broadcasting signal transmitting apparatus using a predetermined scheme thereof to thereby perform an inverse operation of the multiplexer 200 of the digital broadcasting signal transmitting apparatus.

FIG. 8 is a flowchart illustrating a reception method of a digital broadcasting signal according to an exemplary embodiment of the present invention.

Referring to FIG. 8, a digital broadcasting signal receiving apparatus receives a transmission frame 10 from a digital broadcasting signal transmitting apparatus (S201), and extracts a frame header 20 of the received transmission frame 10 (S202).

Then, the digital broadcasting signal receiving apparatus analyzes multiplexing information of data included in a frame body 30 using a frame information unit 22 of the frame header (S203). Then, the digital broadcasting signal receiving apparatus determines whether the analyzed data multiplexing information is appropriate for the corresponding digital broadcasting signal receiving apparatus (S204).

When it is determined that the analyzed data multiplexing information is appropriate for the corresponding digital broadcasting signal receiving apparatus, the digital broadcasting signal receiving apparatus demodulates the received transmission frame 10 using a predetermined scheme of the corresponding digital broadcasting signal receiving apparatus (S205).

The above-mentioned exemplary embodiments of the present invention are not embodied only by a method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICATION

According to the present invention, there may be provided a transmission method, a transmission apparatus, a reception method, and a reception apparatus of a digital broadcasting signal that can support various types of transmission modes in terrestrial digital broadcasting such as a digital television (DTV) or digital multimedia broadcasting (DMB), and a transmission frame structure thereof.

1-8. (canceled)

9. A transmission apparatus of a digital broadcasting signal, comprising:
a stream provider that converts a plurality of services into a stream;
a multiplexer that encodes and modulates the stream; and
a transmission frame generator that generates a transmission frame on the basis of modulation information of the multiplexer and the stream,
wherein the transmission frame comprises a frame header and a frame body,
the frame header comprises the modulation information of the multiplexer and a coding rate, and
the frame body comprises data of the stream.

10. The transmission apparatus of claim 9, wherein the frame header further comprises an error correction code of the stream.

11. The transmission apparatus of claim 9, wherein the multiplexer comprises a plurality of mode modulation units, and
each mode modulation unit comprises:
an encoder that encodes the stream according to a predetermined bit rate;
a media multiplexer that packetizes the encoded stream with respect to each of a plurality of components included in a service;
an external encoder that performs external encoding for error correction on the packetized stream; and
a channel distributor that allocates the external-encoded stream to each subchannel.

12. The transmission apparatus of claim 9, wherein the frame header further comprises synchronization signal information for extracting a start position of the transmission frame.

13. A reception apparatus of a digital broadcasting signal, comprising:
a frame header analysis unit that determines whether modulation information of a received transmission frame is appropriate for the reception apparatus; and
a demultiplexer that demodulates only a transmission frame determined to be appropriate by the frame header analysis unit in accordance with the modulation information.

14. The reception apparatus of claim 13, wherein the frame header analysis unit comprises:
an extractor that extracts a frame header of the received transmission frame;
a multiplexing information analysis unit that analyzes modulation information and coding rate of the transmission frame using the frame header; and
a determination unit that determines whether the multiplexing information is appropriate for the reception apparatus.
